(19) United States
(12) Patent Application Publication
(10) Pub. No.: US 2021/0000695 A1
(43) Pub. Date: Jan. 7, 2021

(54) Artificial Teat

(71) Applicant: Nicola Bateman, Hampshire (GB)

(72) Inventor: Nicola Bateman, Hampshire (GB)

(21) Appl. No.: 16/969,714

(22) PCT Filed: Feb. 22, 2019
(86) PCT No.: PCT/EP2019/054445

§ 371 Date: Aug. 13, 2020

(30) Foreign Application Priority Data
Feb. 23, 2018 (GB) 1802959.5

(51) Int. Cl. A61J 17/00

(52) U.S. Cl. CPC A61J 17/001; A61J 17/105

(57) ABSTRACT

The present invention resides in the soothing of infants, particularly soothing from persistent crying in distressed but healthy infants using an artificial teat having a neck and a head, wherein the head is solid. The teat has particular use for the normalisation of cranial rhythmic impulses in such infants.

The present invention lies in the soothing of infants, particularly soothing from persistent crying in distressed but healthy infants using an artificial teat.

Osteopathic physicians believe that the birthing process causes cranial dysfunction that may be manifested in somatic symptoms, one of which is excessive crying of infancy. Unexplained persistent crying behaviour occurs in 10-30% of infants less than three months old and often leads to primary caregivers seeking medical advice (Douglas and Hill (2011) BMJ, 15: 343, d7772; Morris et al (2001) Arch. Dis. Child. 84: 15-19; Lucassen (2010) Clinical Evidence, 2: 309; McRurry et al (2010) J. Am. Board Fam. Med. 23: 315-322). One option is to offer cranial osteopathy.

The core premise of cranial osteopathy, the Primary Respiratory Mechanism, was first described more than 70 years ago by Sutherland (The Cranial Bowl. Mankato, Minn.: Free Press Co; 1939, reprinted, 1986). The five components of the Primary Respiratory Mechanism are inherent fluctuation of Cerebrospinal fluid, motility of the Central Nervous System, mobility of the reciprocal tension membranes, motion of cranial bones, the involuntary motion of the sacrum between the iliac bones of the Pelvis (Kern. M., Wisdom In The Body (2001), Thorsons). The primary respiratory mechanism is said to function in an oscillatory manner with inspiratory (flexion, external rotation) and expiratory (extension, internal rotation) phases. When palpated on the head, the primary respiratory mechanism is referred to as the cranial rhythmic impulse (CRI).

The term ‘Cranial Rhythmic Impulse’ describes slow pulsatile movements that the body exhibits. Many low-frequency oscillations in the 6 to 9 cpm (0.1-0.15 Hz) range are found in the human body, such as blood pressure, blood flow velocity (Traube-Hering (TH) oscillation), heart rate (R-to-R interval) variability, sympathetic tone in muscle, and intracranial fluid oscillations. These phenomena can be directly or indirectly linked to oscillations in the autonomic nervous system, particularly the sympathetic nervous system. The CRI, with reported rates ranging from 4 to 14 cpm (0.06-0.23 Hz), shares the spectral frequency band with these aforementioned physiologic oscillations. The CRI has been shown to correspond to the low-frequency TH in blood flow velocity (Nelson et al (2001) J. Am. Osteopath. Assoc. 101: 163-173). In addition, it has been demonstrated that manual cranial techniques affect TH (Sergueef et al (2004) Alternative Therapies in Health and Medicine. 8: 74 76; Nelson et al (2004) Amer. Acad. Osteopath. J. 14: 15-17) and similar low-frequency oscillations in intracranial fluid (Moskalenko & Kravchenko (2004) Amer. Acad. Osteopath. J. 14: 29-40.).

In 2009, Kotzampaltiris et al examined whether an abnormal CRI is associated with excessive crying of infancy (J. Alternative and Complementary Medicine (2009), 15(4): 341-345). One hundred and thirty-nine full term infants were assessed for the presence of excessive crying. Of the sample, 41.7% of the infants showed excessive crying. Excessive crying was associated with an abnormal CRI at 2 weeks but not with the CRI at birth. Indeed, infants with an abnormal CRI at 2 weeks were 6.8 times more likely to develop excessive crying than infants with a normal CRI, suggesting that reduced cranial rhythm is a contributing factor to excessive crying in young infants.

Developments in anatomy, behaviour and science also describe the Autonomic Nervous System (ANS) as not simply being an autonomic and sympathetic in response but also having a third important component, namely a ‘Social Nervous System’. Collectively known as the Triune Nervous System. The Social Nervous system aspect enables a baby to develop important social behaviour such as maternal bonding. It is a neuro-physiological phenomenon whereby a baby, for example, is able to orient itself to mother, communicate, find her breast, nurse, co-ordinate sucking, breathing and swallowing. All divisions of the ANS interrelate with each other.

Persistent crying in a baby indicates overwhelm and trauma in the Triune Nervous System (Porges. S., Psycophysiology (1995) 32; Porges. S., Int. J. Psychophysiology (2001) 42:123-146; Porges. S., Biological Psychology (2007) 74(2):116-143; Porges. S., The Polyvagal Theory (2012) in Sills. F. Foundations in Craniosacral Biodynamics (2012) Vol 2. North Atlantic Books).

New-born and premature babies are subject to the post-traumatic stress of labour, especially after medical assistance with forceps, ventouse or Caesarean section. Even for babies born after a trouble-free natural labour, their skull will have been squeezed to allow it to pass through the birth canal and the skull needs to rebalance and relieve strain patterns. Babies are born with a sucking reflex which assists in the rebalancing and relieving process.

It has been noted that babies, particularly those born after medical intervention, derive particular benefit from sucking on a little finger of a parent, nurse or midwife, with the finger reaching to the roof of the mouth or hard palate.

The portion of the skull lying immediately above this region of the mouth comprises the palatine and maxilla bones with two sutures, the median palatine suture and the transverse palatine suture. These sutures influence the sphenoid bone which overlies the palatine and maxilla bone structures and extends to either side of the mouth. The benefit achieved by sucking a finger is believed to be because balance of this structure including the palatine, maxilla and sphenoid bones is crucial to the mechanics of the skull, not least because this structure lies at the centre of the head.

The cranial base and sphenobasilar junction (SBJ) are known in Osteopathic and Craniosacral literature as the natural fulcrum around which bony motility happens. It is also the most superior pole of the embryological notochord. Major cranial nerves pass by or through the cranial base. Therefore, impingement or stress in this area can affect whole body nerve function. It has been noted as an area that causes respiratory and digestive issues in infants and imbalances here can affect the autonomic nuclei and neuro-endocrine-immune system (Sills F., The Sentient Embryo, Tissue Intelligence and Trauma Resolution (2012) Foundations in Craniosacral Biodynamics, Vol 2, North Atlantic Books).

At birth, a baby's skull has immature sutures, wide open fontanelles which generally remain open and flexible up to 15 months old to allow for rapid growth of the size of the human brain during that period. The Sphenoid bone is also in three parts at birth and the occiput is in four parts. Both bones form the cranial base and in particular orient together as the Sphenobasilar junction (SBJ).

Strain patterns occur in the head and spine during pregnancy and/or birth and plagiocephaly can arise due to the flexibility that is present in the skull. These strain patterns may also continue or arise after birth following guidance always to place a baby on its back to avoid the possibility of cot death syndrome.

If left uncorrected, strain patterns and plagiocephaly contribute to other physical and emotional challenges of childhood, including dyslexia, attention deficit hyperactivity disorder (ADHD), headaches, colic, irregular head shape, irritable children, reflux, poor sleeping patterns, emotional issues and lack of growth. Medical intervention, such as cranial adjustment and chiropractic, may result in dramatic improvement. Research has shown that when a baby's skull and body rebalance, the child will relax, sleep and start to thrive. However, as a baby grows, strain patters such as dips and ridges in the head may re-establish so further or continued intervention is required. However, as detailed above, such intervention requires an experienced professional and the success is highly dependent on the competency of such a professional.

An alternative is to harness the natural sucking reflex of an infant and to provide a dummy, soother or pacifier that is designed to exert an appropriate force, contact and/or mobilisation stimulation on the hard palate. Pacifiers typically have a hollow, flexible teat. As a result, such a pacifier is not able or designed to exert an appropriate force on the hard palate, not least because, on sucking, the teat is compressed and the three-dimensional shape is collapsed. Infants who are in need of the rebalancing described above usually reject such a pacifier because it does not provide the relief that the infant seeks.

Pacifiers are available, such as that sold by Difrax®, that have an upwardly angled teat shaped to bear against the hard palate. Such pacifiers are sold as having benefits for the development of the jaw and palate. However, again, such pacifiers are hollow and so suffer from the same drawbacks as ordinary pacifiers.

WO 2012/101409 describes a pacifier having a straight, essentially unshaped teat that is angled upwards in use to bear against the hard palate. The teat is solid having a solid inner core and a softer outer layer. The drawback of such a pacifier is the risk that the outer layer may tear and separate from the core, providing a possible choking risk.

The present invention is derived from the finding that an infant sucking on a human finger often obtains better relief and soothing than using an ordinary commercial, hollow teat, particularly when some infants reject numerous, commercially available pacifiers but all infants can and will suck on a human finger. Accordingly, the present invention lies in a pacifier teat that overcomes the drawbacks of existing pacifiers and provides the relief achieved with sucking a human finger.

Specifically, the present invention resides in an artificial teat for use as a pacifier, the teat being a single unit having a neck and a head, wherein the head is solid. Such a teat is believed to activate temporal pulses in the superficial temporal arteries of the head (located in front of the ears) which is an indication of increased blood flow. The teat also stimulates the cranial rhythmic impulse in the nervous system which gives improved health benefits. In particular, the teat increases the sucking reflex which helps to stimulate the production of oxytocin. In a young infant, oxytocin is a natural pain relief after birth and reduces fight/flight hormonal symptoms thereby resulting in a more relaxed infant.

In one embodiment, the neck and head of the artificial teat are flexible relative to each other. It will be understood that flexibility may be imparted by any suitable means, for example, different Shore Hardnesses for the head and neck, or a neck that is suitably narrow in its width, depth and/or height, to impart flexibility to the teat as a whole and/or the head relative to the neck.

In one embodiment, the flexibility may be achieved by the teat including a waist, or narrowing, in its width and/or depth where the neck meets the head or tip. The inclusion of a waist or narrow profile imparts flexibility to the teat, so the angle of the head or tip of the teat in the mouth may be controlled by changing tongue position and shape. This flexibility allows the user to move the teat within the mouth to maximise the pacifying and soothing effects. The waist also allows the teat to be supported from the inside of the lips and thus helps keep the teat within the mouth, rather than falling out under its own weight.

Alternatively or in addition, the neck may include a cavity. The cavity in the neck of the teat imparts increased flexibility to the teat, from where the teat emerges from a shield at a frontal plane of the teat to approximately the midway of the teat and towards the anterior tip of the teat. This enables the solid head of the teat to be moved around easily in the mouth.

While the length of the neck, from where the teat extends from a face shield towards the head or tip of the teat, will depend on the age and size of the user, the length is ideally less than about 30%, for example between about 20% to 30%, of the total length of the teat. In one embodiment, the neck has a length that is 25% of the total teat length. In another embodiment, the neck has a length that is 21% of the total teat length.

The head of the teat is solid, meaning that it is made from the same material throughout and contains no cavities. A sold head provides a firm and stable shape that, when sucked, applies pressure to the roof of the mouth. The application of pressure to the roof of the mouth (hard palate) activates and moves the cranial bones and soft tissues which form the base of the skull.

Preferably, the solid head has a Shore hardness for medical grade silicone rubber of between about 10 and 30. A Shore hardness of around 18 to 25, for example 20, has been found to be particularly suitable for the teat head of the present invention. Shore Hardness is a measure of the resistance a material has to indentation, with the lower the Shore hardness, the more flexible the material. The solid teat is necessary to transfer pressure to the roof of the mouth, from midway to the anterior tip of the teat, so that the roof of the mouth is stimulated. It will be appreciated that the Shore hardness, and therefore density, of the teat may be varied according to the needs of infants, either in terms of age, severity of discomfort and length of time of use of the teat of the present invention.

A teat that has a Shore hardness of around 40 is typically rejected almost instantly by an infant, presumably because the hardness does not provide effective comfort and possibly causes discomfort. While a teat that has a Shore hardness of around 7 is generally acceptable to an infant, the hardness provides no discernible difference to improving or stimulating the cranial rhythm and so is believed to be ineffective in its role as a pacifier in infants where CRI is disturbed.

The head of the teat is angled upwards from the transverse (horizontal) plane such that, in use, the upper surface of the head aligns with and follows the shape of the roof of the mouth. This makes the transfer of pressure from the teat to the roof of the mouth more effective. The centreline of the teat head deviates from the transverse (horizontal in use) plane at an angle of between about 15 degrees and about 25 degrees, preferably about 20 degrees.

The shape of the teat head is important for the comfort and effectiveness of the teat. In particular, the head is shaped to bear against the hard palate to mobilise the soft tissues and sutural connections and stimulate more active movement within the infant's mouth, freeing up their tongue muscles. It is suggested that this active movement stimulates a rebalancing cascade of positive endocrinal activities and hormonal benefits such as oxytocin production, thereby mimicking sucking on the breast. This, in turn, provides a more effective soothing response.

When viewed from above or below, the teat head may have a substantially rectangular shape having outwardly flaring shoulder where the teat expands in width from the neck to the head. The head has straight sides finishing in a curved tip. The width of the head may be between about 15 and 20 mm while the length of the head may be between about 20 and 30 mm. It will be appreciated that the length and width of the head will depend on the age and weight of the infant. For example, premature and low birth-weight babies may require a smaller teat than full term, average weight babies.

When viewed from the side, the upper surface of the head in use has a convex profile that mimics the concave shape of the hard palate. In this way, the head fits the shape of the roof of the mouth, from the waist of the neck to the tip or end of the head, so pressure is transferred more evenly. The profile rises more gently from the waist to the highest point of the curve than it falls from the highest point to the tip. In particular, the profile rises at an angle of approximately degrees 25-30 degrees, such as 28 degrees, from the horizontal plane, from the waist towards the tip of the head. The curve reaches an upper, horizontal plateau before falling at an angle of between 40 and 50 degrees, approximately degrees 45 degrees, towards the tip of the head. The uppermost point on the upper surface of the head is horizontal, while the furthest extent on the tip of the teat is substantially perpendicular to the horizontal plane. When viewed from the tip towards the neck, the upper surface of the head in use has a generally semi-circular profile.

The lower surface of the head in use has a concave profile from the neck to the tip and across the width of the head. The profile has a smaller curvature than the upper surface and provides a shape that fits the tongue for comfort and increased control of the solid head.

It will be appreciated that the teat may be made from any suitable medicinal-grade silicone or rubber. However, materials that disperse saliva better on their surfaces (more ‘wettable’ materials) adhere better in the mouth. To wet the surface, the material must have a higher surface free energy than the saliva has surface tension.

For the present application, materials such as natural latex and polyethylene terephthalate (PET) are believed to be particularly suitable because they have a high surface free energy.

Surface tension in saliva provides a small adhesive force, but an enhanced or increased adhesion effect may be achieved by the addition of microstructure (surface roughness on the micrometer scale). However, for microstructure adhesion to work, it must work in combination with a wettable surface. Accordingly, the outer surface of the teat may have a textured surface, such as a micro texture. This texture aids wetting and improve adhesion when in contact with saliva, thus retention of the teat in the mouth is improved.

In a preferred embodiment, the teat is attached to a shield to prevent the infant from swallowing the teat. It will be appreciated that any suitable pacifier or soother shield may be used.

Ideally, the shield is rigid and made from copolymer or homopolymer polypropylene suitable for food contact to maintain hygiene.

When testing the teat of the present invention, it was found that the teat and shield (referred to herein as a “pacifier” when combined) tended to fall out without assistance and needed to be held in place by the infant. It was ascertained that the weight of the shield is important.

Accordingly, in one embodiment, the shield is a substantially rectangular frame having a curvature shaped substantially to mirror that of an infant's face around the mouth. The frame of the shield or its perimeter may include arcuate corners and a recess or dip in its shape. It will be appreciated that the dip is provided in the top edge of the frame when the pacifier is in use so the shield does not impede or interfere with the nose, breathing is not impaired and correct orientation of the teat is readily identified.

If the shield is a solid plate, it is preferred if the plate includes one or more holes to allow the skin beneath to breath and perspire when the pacifier is used. Ideally, such holes are maximised to reduce the weight of the pacifier. For example, the holes may comprise between about 30%-45% of the shield. In a specific example, the area of the shield may be about 1628 mm² and may include holes having an area of about 552 mm². Such an arrangement provides a porosity of about 34% to the shield. In terms of weight reduction for this specific example, the volume of the shield without the holes may be about 4448 mm³ while the volume of the shield with holes may be about 3119 mmm³. In this specific example, the weight reduction is about 29%. Expressed in another way, the holes remove about 29% of the weight. Thus, the holes may reduce the weight of the shield by between about 20 and 40%.

A reduction in the weight of the shield also assists in moving the centre of mass of the pacifier inside the mouth which, in turn, improves retention of the teat in the mouth without assistance from a hand.

Indeed, the position of the centre of mass of the pacifier is important for retention of the teat within the mouth. In particular, force analysis has showed that tongue pressure, when not sucking, increases the reaction force on the palate. This reaction has a component that directs the pacifier out of the mouth. Also, positioning of the centre of mass may cause the pacifier to rotate which could propagate ejection of the pacifier. So, ideally, the centre of mass should reside between the lips and gums.

The shield also forms part of the contact perimeter, the size of which contributes to the adhesive force. Accordingly, the surface of the shield that contacts the face may include a texture in the form of a micro-texture.

In one embodiment, the shield includes a knob or button that projects away from the teat and, when in use, out from the infant's face. Such a projection provides a grip allows the pacifier to be held for insertion, movement within the mouth and removal.

It will be appreciated that the knob or grip adds weight to the shield and so its design needs to be taken into consideration to ensure the addition of the extra weight does not make the teat prone to ejection or falling out under the weight of the shield. The grip is preferably moulded from the same material as the shield and so is rigid and made from copolymer or homopolymer polypropylene suitable for food contact.

The face of the grip that, in use, faces away from the infant, may include a recess. Ideally such a recess is sized to fit an adult fingertip, so the pacifier may be supported and manoeuvred by a caregiver while in use.

The present invention also encompasses use of a teat as described herein in the treatment or soothing of discomfort in an infant or a method of treating or soothing a discomforted infant. Ideally, the infant is healthy but may have abnormal or disrupted cranial rhythmic impulses. Expressed in another way, the present invention resides in use of the teat to normalise cranial rhythmic impulses and/or to treat abnormal cranial impulses in an infant. The teat of the present invention may also be used to rebalance or improve somatic dysfunction in an infant. Somatic dysfunction may be defined as impaired or altered function of related components of the somatic system, including skeletal, arthrodial, and myofascial structures and related vascular, lymphatic, and neural elements. For example, the soother is believed to assist in the resolution of compressive or inertial forces that are held at the sphenobasilar junction (SBJ) resulting from pregnancy, the birth process and post birth events/experiences. The sphenoid bone is the keystone structure or gear lever in the skull (Kern. M. 2001 (supra), Sills. F. 2012 (supra)). If it is out of balance, the autonomic nervous system is under pressure and CRI is reduced. Indeed, Waddington et al (J. Am. Osteopath Assoc. 2015 November; 115(11):654-65) found that the majority of healthy new borns had somatic dysfunction with at least one sphenoid strain pattern. The more strain patterns an infant has, the more unhappy the infant is, which triggers colic and other symptoms such as persistent crying.

Without wishing to be bound by theory, the soother of the present invention is believed to exert its effect on the palette, sutural connections, soft tissues and muscles of the tongue. In particular, it is believed that the soother delivers a combination of reaction forces to help normalise or aid self-correction of the natural movement of the SBJ. It also helps normalise the components of the Primary Respiratory Mechanism. This is achieved via sucking, tongue movement and a soother in the configuration as described herein.

The infant may be otherwise apparently healthy. Equally, the infant may be sick, carrying disease or abnormalities or be otherwise not healthy. An infant is defined as being from the age of new born up to about 2 years of age. The definition encompasses premature babies.

While the teat of the present invention has been described with reference to its use in calming healthy but distressed infants, it will be appreciated that its use may also encompass soothing and stimulating the sucking reflex of infants who cannot or are unable to be breast-fed. It may also be for infants who face medical challenges such as a cleft palate or Downs syndrome.

It will be appreciated that such uses encompass methods of treatment.

The present invention will now be described in further detail with reference to non-limiting examples shown in the figures, in which:

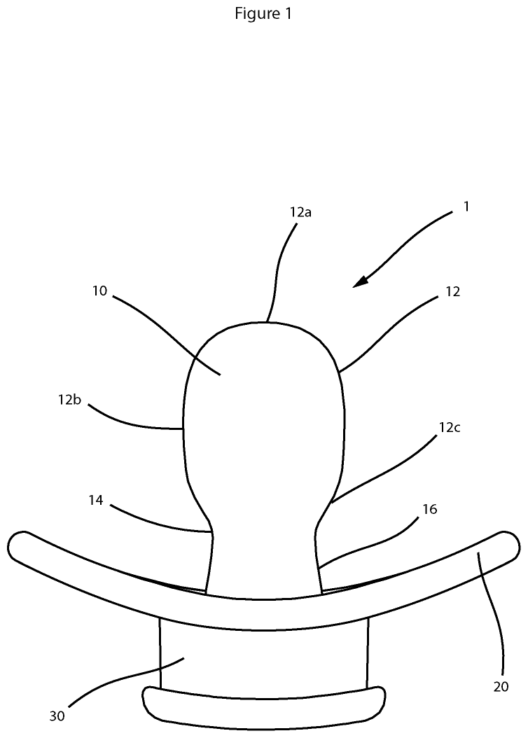

FIG. 1 is a view from above of a pacifier including a teat of the present invention;

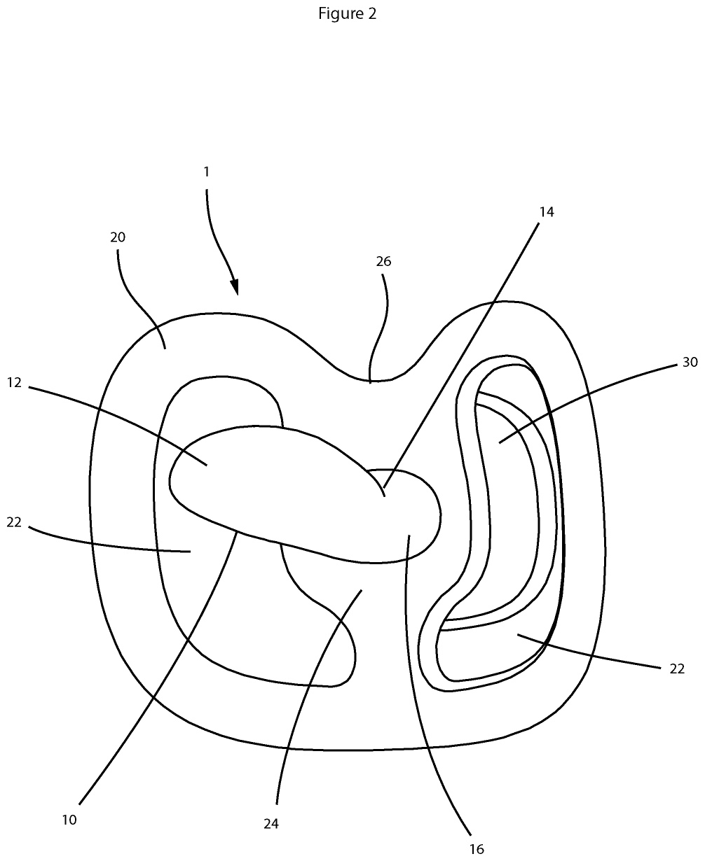

FIG. 2 is a perspective view from the end of the teat of the present invention, towards a pacifier shield;

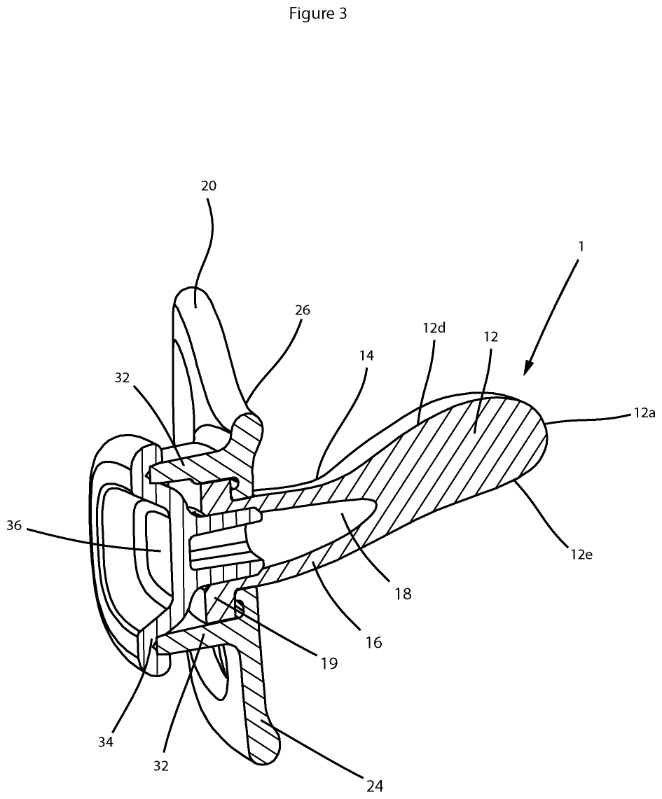

FIG. 3 is a perspective cross section view from one side of a pacifier including the teat of the present invention; and

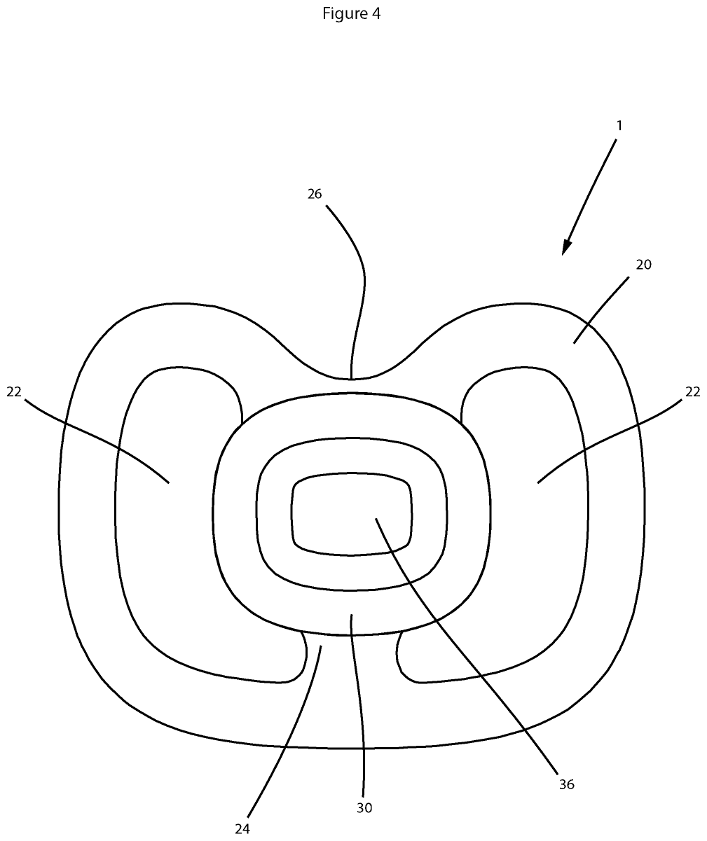

FIG. 4 is a view of the one end of a pacifier, illustrating the shield and grip.

FIG. 1 shows a pacifier 1 including a teat 10, a shield 20 and a grip 30. The teat 10 has a head 12, a waist 14 and a neck 16.

When viewed from above, the head 12 has a substantially rectangle shape with a rounded or curved tip 12a, straight side edges 12b and shoulders 12c that slope inwards from the side edges 12b. The base of the head 12, i.e. the point at which the head 12 is at its narrowest, forms the waist 14 on the teat 10.

The neck 16 widens in width from the narrowest part of the shoulders 12c on the head 12 towards the shield 20, with the narrowest part of the neck 16 forming the waist 14 of the teat 10.

The shield 20 has a curvature that substantially mirrors the curvature on the front of an infant's face across the width of the mouth. Although not shown, the end of the neck 16 away from the waist 14 of the teat 10 is a free end that is embedded within the structure of the shield 20.

Grip 30 extends outwards from the middle of the shield 20, away from the teat 10.

FIG. 2 shows the head 12 of the teat 10 being angled upwards away from the horizontal plane as the teat 10 extends away from the shield 20.

The shield 20 is a substantially rectangular frame with rounded corners. The frame resembles a pair of ears having a left and a right, with the centre of each ear being empty of material to provide vent holes 22. The two ears are bisected by a central pillar 24 to which the base of the neck 16 of the teat 10 is attached. The central pillar 24 also adds structural stability to the shield 20. There is a dip 26 in the shaping of the shield 20 at the point at which the upper end of the central pillar 24 joins the shield 20 when in use. This dip 26 provides clearance for the nose so the shield 20 does not impede breathing.

FIG. 3 illustrates the shaping of the teat 10. As can be seen, the head 12 of the teat 10 is angled upwards from the horizontal plane of the pacifier 1. The upper surface 12e of the head 12 has a convex profile, with a shallow rise from the waist 14 towards the apex of the curve. The profile the descends quickly to tip 12a which is semi-circular in profile. The lower surface 12e of the head 12 has a shallow convex profile from the tip 12a to the waist 14 and between sides 12b.

FIG. 3 also shows the cavity 18 in the neck 16 that extends from the waist 14 of the teat 10 to the shield 20. The shape of the cavity mirrors the external shape of the neck 16 so the thickness of the wall of the neck 16 is the same around the circumference of the neck 16.

FIG. 3 shows how the pacifier 1 is assembled. The free, open end of the neck 16 includes a collar 19 that describes the circumference of the base of the neck 16. The collar 19 sits on the inside surface of a shoulder on the face of the shield 20 that faces the teat 10.

In the middle of shield 20, a wall 32 extends away from the teat 10, perpendicular to the shield 20, forming the side wall of the grip 30. The front face 34 of the grip 30 is a shaped plate that is a click-fit over the open end of wall 32. The front face 34 also includes a recess 36, to which is attached an internal protrusion that locates inside collar 19 of the teat 10 when the pacifier 1 is assembled.

FIG. 4 illustrates the shield 20 and grip 30. The grip 30 has a substantially rectangular shape with rounded or arcuate corners. Indeed, the shape of the grip in the embodiment shown is the same, scaled-down shape as the shield 20. The grip 30 has front face 34 with an outer circumference that is shaped and sized to co-operate with walls 32 shown in FIG. 3. The grip 30 has a depth that forms a recess 36 that is sized to fit an adult fingertip.

Osteopaths and cranial-sacral therapists are trained to be able to feel and assess for the motion of the skull bones, tissues and circulation with their hands. Infants using a pacifier including the teat of the present invention were assessed before and whilst using the pacifier. It was found that the pacifier stimulated and normalised cranial rhythms. The same infants were also assessed using an ordinary pacifier and, although soothing for an infant, the ordinary pacifier did not affect cranial rhythms. Hands-on cranial tests demonstrated physiological benefits, improved soothing response and a reduction in persistent crying in distressed but healthy infants. In the sample (n=22), 82% (n=18) accepted the pacifier described herein.

Eighteen infants aged between 1-12 weeks old were involved in a non-randomised intervention feasibility study to test the soother described here. All participants received the soother described herein in addition to regular treatment and questionnaires at baseline, 2 and 4 weeks follow-up. All participants were invited to participate in a 30 minute semi-structured interview after 4 weeks follow-up to find out about their experience using the soother.

Parent/s and infant with unexplained infant crying who meet the inclusion criteria were recruited from online support platforms, groups and paediatric chiropractor clinics.

Detailed feedback in the form of qualitative interviews was forthcoming from nine parents. Chiropractors involved with the study fed back experiences from a further three parents and six parents did not volunteer feedback.

The infants presented in four Chiropractic clinics with a wide range of symptoms and diagnoses. Common ones were distress, excessive day and night time crying, not sleeping, constipation, unable to lie comfortably on their backs, colic and reflux. On examination, it was found that these infants had a wide range of cranial imbalances such as tension in the jaw, facial irregularities, palette compression, mild plagiocephaly and other structural patterns. Interestingly, the structural findings reflect those identified by Waddington et al (supra). Waddington et al found that, out of one hundred new-borns examined, 99% of them had at least one sphenobasilar synchondrosis strain pattern, with other cranial restrictions.

The majority of parents of infants in the present study had already sought help and advice from other medical professionals such as midwives or GPs. Several were on prescription medication for colic such as Infracol™ and, some were using non-standard milk formulas if not breast fed. Where possible, the infants were offered the use of the soother prior to receiving chiropractic, cranial or cranial-sacral therapy as a way to test for acceptability before a further intervention was offered.

Most of the infants had already tried standard commercially available soothers and some of them could use one and some parents expressed a reluctance or distrust in using a standard soother. The infants were difficult to settle using normal parenting soothing methods, including standard soothers, and for many mothers, their infants only appeared to find relief when on the breast, even when not hungry, which was stressful for those mothers, and in some cases, led to Mastitis and difficulties with feeding. This also created tension and anxiety that they were not being a good parent (including fathers/other caregiver) through not knowing how to successfully comfort and soothe their infant.

The average length of time the soother was needed and regularly used by an infant varied but, overall, was approximately 2-3+ weeks. It is possible that the soother described herein is working more effectively and faster than anticipated.

The key findings are:
babies as young as 7 days old up to 12 weeks old could successfully use the soother. Sixteen out of eighteen infants in the group used the soother.
eight out of nine parents interviewed by an independent researcher or through questionnaire feedback said they had found between ‘some’ and ‘much benefit’ from using the soother for their baby.
chiropractors fed back that the soother appeared to be ‘really helpful and useful to very distressed infants’. One reported that, for some infants, using the soother was ‘helpful in addition to and over and above the standard treatment’ given by the chiropractor.
a common reported benefit for parents was the relief they felt from using the soother because, up until the soother was offered, the baby would not settle even though not hungry or when they were distressed and nothing else would settle them including having tried standard commercially available soothers. Parents reported that the soother really soothed their baby and in particular helped them to move into and stay in a deep sleep. This meant that both infants and parents could get some rest, as well as extending and establishing better sleeping patterns in these infants.
use of the soother appeared not to inhibit or affect feeding methods. Infants were successfully able to use the soother whether breast or bottle fed. The use of this soother in young infants did not affect, compromise or reduce breast feeding. The use of the soother allowed three mothers with sore nipples and mastitis to recover. Instead of constant cluster feeding (feeding in frequent short bursts) on the breast by a distressed infant for non-nutritive purposes, this soother was a good acceptable substitute. As an unexpected outcome, it led to these mothers being able to continue with breast feeding rather than giving up through on-going discomfort. The use of the soother reduced discomfort generally for all mothers who were breast feeding and helped them to identify when an infant had a need to suck or chew rather than being hungry. The outcome of being able to pace breastfeeding or bottle feeding helped to reduce colic and reflux symptoms by giving infants more time to digest and absorb a previous feed.
both chiropractors and parents noted that the soother stimulated deeper and stronger natural sucking by infants. This means that an infant is not only exercising and actively mobilising their tongue muscles but also improving co-ordination resulting in more effective faster feeding. A problem with short feeding episodes can be that an infant is unable to fill themselves up with the highly nutritious fat enriched hind milk within the rear of the breast. Access to the hind milk requires an effective tongue and co-ordinated sucking reflex.
in one case, once the soother was used by an infant, the parent was able to stop using all prescribed medication for colic.
it was noted that the earlier this soother was introduced for an infant (ideally between 1-4 weeks), there was a greater overall impact reported by parents about an infant's wellbeing. In addition, the soother was generally more easily accepted and used by an infant. This also resulted in improved confidence and contentment within mothers, particularly for first time mothers.

This was a preliminary evaluation of the use of the soother described herein with distressed infants and their parents. There were limitations in terms of the methodology and in collecting the data, not least because undertaking research on a highly sensitive subject involving very young infants and stressed parents is difficult. Parents found that the soother helped their infants when nothing else had, including having already tried a variety of commercially available soothers.

The soother as described herein assists in relieving somatic dysfunction within a healthy infant by providing active relief, reducing symptoms in distressed babies and better soothing. This relief is possible for an infant to enjoy up to 12+ weeks old.

1. An artificial teat for use as a pacifier, the teat being a single unit having a neck and a head, wherein the head is solid.

2. An artificial teat according to claim 1, wherein the neck and head are flexible relative to each other.

3. An artificial teat according to claim 1, wherein the teat includes a waist, or narrowing, in its width and/or depth where the neck joins the head.

4. An artificial teat according to claim 1, wherein the neck includes a cavity.

5. An artificial teat according to claim 1, wherein the neck has a length that is less than about 30% of the total length of the teat, or optionally the neck has a length that is between about 20% to 30% of the total length of the teat.

6. (canceled)

7. An artificial teat according to claim 1, wherein the head has a Shore hardness for medical grade silicone rubber of between about 10 and 30, or optionally the head has a Shore hardness for medical grade silicone rubber of between about 18 and 25.

8. (canceled)

9. An artificial teat according to claim 1, wherein the head is angled upwards from a transverse (horizontal) plane.

10. An artificial teat according to claim 1, wherein the head has a width of between about 15 and 20 mm, and/or the head has a length of the head of between about 20 and 30 mm.

11. (canceled)

12. An artificial teat according to claim 1, wherein the head includes a convex upper surface, and/or the head includes a concave lower surface.

13. (canceled)

14. An artificial teat according to claim 1, wherein the teat is made from natural latex or polyethylene terephthalate (PET).

15. An artificial teat according to claim 1, wherein the teat includes a textured surface, and/or wherein the teat includes a micro-textured outer surface.

16. (canceled)

17. An artificial teat according to claim 1, wherein the teat is attached to a shield.

18. An artificial teat according to claim 16, wherein the shield includes one or more vent hole, and/or wherein the one or more vent hole comprises between about 30%-45% of the shield.

19. (canceled)

20. An artificial teat according to claim 16, wherein the shield includes a textured surface on the face that, in use, contacts a user, and/or wherein the textured surface includes a micro-texture.

21. (canceled)

22. An artificial teat according to claim 16, wherein the shield includes a grip on a face opposite the teat.

23. An artificial teat according to claim 22, wherein the grip includes a recess.

24. An artificial teat as claimed in claim 1 for treating or soothing discomfort, or normalizing cranial rhythmic impulses in an infant.

25. An artificial teat as claimed in claim 24, wherein the infant has abnormal or disrupted cranial rhythmic impulses.

26. (canceled)

27. An artificial teat as claimed in claim 24, wherein the infant is healthy.

28. An artificial teat as claimed in claim 24, wherein the infant is from new born up to about 2 years of age.
